(19) United States
(12) Patent Application Publication
(10) Pub. No.: US 2016/0019857 A1
(43) Pub. Date: Jan. 21, 2016

(54) DISPLAY DEVICE AND METHOD OF DRIVING A DISPLAY DEVICE

(71) Applicant: SAMSUNG DISPLAY CO., LTD., Yongin-City (KR)

(72) Inventors: Hyun-Ho LIM, Jecheon-s (KR); Byeong-Doo KANG, Cheonan-si (KR)

(21) Appl. No.: 14/584,453

(22) Filed: Dec. 29, 2014

(30) Foreign Application Priority Data
Jul. 21, 2014 (KR) 10-2014-0091683

(51) Int. Cl. G09G 5/00

(52) U.S. Cl. CPC G09G 5/00; G09G 2330/02

(57) ABSTRACT

A display device includes a display panel, a scan driver, and a data driver. The scan driver applies a scan signal to a pixel of the display panel. The data driver determines a transmission duration of at least one intermediate data voltage based on a transmission distance from the data driver to the pixel. The data driver sequentially applies the intermediate data voltage and a target data voltage to the pixel based on the transmission duration of the intermediate data voltage during an active period of the scan signal.

### CROSS REFERENCE TO RELATED APPLICATION

Korean Patent Applications No. 10-2014-0091683, filed on Jul. 21, 2014, and entitled, “Display Device and Method of Driving A Display Device,” is incorporated by reference herein in its entirety.

### BACKGROUND

1. Field

One or more embodiments described herein relate to a display device and method of driving a display device.

2. Description of the Related Art

A display device typically includes a data driver, which applies a data voltage to a pixel through a data line. In operation, capacitive loads may form between the data line and adjacent signal lines. The data line may also include a resistive loads. As a result, a certain charging time may be required for a voltage level of the data line to reach a target data voltage. The charging time may be proportional to the resistance of the data line, e.g., charging time increases as the data voltage transmission distance from the data driver to a target pixel increases. Thus, a voltage level of each portion of the data line may be different each other, while the data voltage changes at the data line.

Further, power (or energy) may be unnecessarily consumed at the data line. This may result, for example, from the capacitive loads between the data line and adjacent signal lines, and the resistive loads of the data line.

### SUMMARY

In accordance with one embodiment, a display device includes a display panel including a pixel; a scan driver to apply a scan signal to the pixel; and a data driver to determine a transmission duration of at least one intermediate data voltage based on a transmission distance from the data driver to the pixel, the data driver to sequentially apply the intermediate data voltage and a target data voltage to the pixel based on the transmission duration of the intermediate data voltage during an active period of the scan signal.

The data driver may apply the intermediate data voltage to the pixel during a first portion of the active period corresponding to the determined transmission duration, and may apply the target data voltage to the pixel during a second portion of the active period following the first portion of the active period. The intermediate data voltage may have a voltage level lower than a voltage level of the target data voltage.

As the transmission distance increases, the transmission duration of the intermediate data voltage may decrease, and a transmission duration of the target data voltage may increase. The transmission duration of the intermediate data voltage may be based on a voltage of a portion of a data line adjacent to the pixel reaching the target data voltage at an end point of the active period of the scan signal.

The data driver may apply an emphasis voltage as the intermediate data voltage to the pixel, and a voltage level of the emphasis voltage may be higher than a voltage level of the target data voltage.

The data driver may apply a first voltage as the intermediate data voltage to a first pixel located at a first distance from the data driver, and may apply a second voltage as the intermediate data voltage to a second pixel located at a second distance from the data driver, and the second distance may be greater than the first distance, the first voltage may be a voltage level lower than that of the target data voltage, and the second voltage may be a voltage level higher than that of the target data voltage.

The intermediate data voltage may be generated by a voltage divider which divides the target data voltage. The voltage divider may be in the data driver.

The at least one intermediate data voltage may include a plurality of intermediate data voltages having different voltage levels, and the data driver may sequentially apply the intermediate data voltages and the target data voltage to the pixel. The voltage levels of the intermediate data voltages may be lower than a voltage level of the target data voltage. The timing controller may calculate the transmission distance and to control the scan driver and the data driver.

In accordance with another embodiment, a method for driving a display device includes generating a scan signal; determining a transmission duration of at least one intermediate data voltage according to a transmission distance from a data driver to a pixel; and sequentially applying the intermediate data voltage and a target data voltage to the pixel based on the determined transmission duration of the intermediate data voltage during an active period of the scan signal.

Sequentially applying the intermediate data voltage and the target data voltage to the pixel may include applying the intermediate data voltage to the pixel during a first portion of the active period corresponding to the determined transmission duration; and applying the target data voltage to the pixel during a second portion of the active period following the first portion of the active period. The intermediate data voltage may have a voltage level lower than a voltage level of the target data voltage.

As the transmission distance increases, the transmission duration of the intermediate data voltage may decrease, and a transmission duration of the target data voltage may increase. The transmission duration of the intermediate data voltage may be based on a voltage of a portion of a data line adjacent to the pixel reaching the target data voltage at an end point of the active period of the scan signal.

An emphasis voltage may be applied as the intermediate data voltage to the pixel, and a voltage level of the emphasis voltage may be higher than a voltage level of the target data voltage. A first voltage may be applied as the intermediate data voltage to a first pixel located at a first distance from the data driver, and a second voltage may be applied as the intermediate data voltage to a second pixel located at a second distance from the data driver, and the second distance may be greater than the first distance, the first voltage may have a voltage level lower than that of the target data voltage, and the second voltage may have a voltage level higher than that of the target data voltage.

The at least one intermediate data voltage may include a plurality of intermediate data voltages having different voltage levels, the intermediate data voltages and the target data voltage may be sequentially applied to the pixel, and the voltage levels of the intermediate data voltages may be lower than a voltage level of the target data voltage.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an example of a data line connected between a data driver and a pixel, and a scan line connected between a scan driver and the pixel;

FIG. 3 illustrates an example of a data line connected to the data driver;

FIG. 4A illustrates an example of a data voltage from a data driver, and FIG. 4B illustrates an example of a voltage of a portion of a data line changed by the data voltage in FIG. 4A;

FIG. 5A illustrates an example of a node voltage of a portion of a data line changed by the data voltage of FIG. 4A, FIG. 5B illustrates an example of a node voltage of another portion of a data line changed by the data voltage of FIG. 4A, and FIG. 5C illustrates an example of a node voltage of another portion of a data line changed by the data voltages of FIG. 4A;

FIG. 6A illustrates another example of a data voltage applied from a data driver, and FIG. 6B illustrates an example of a voltage of a portion of a data line changed by the data voltage of FIG. 6A;

FIG. 7 illustrates an example of a voltage divider; and

FIG. 8 illustrates an embodiment of a method for driving a display device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

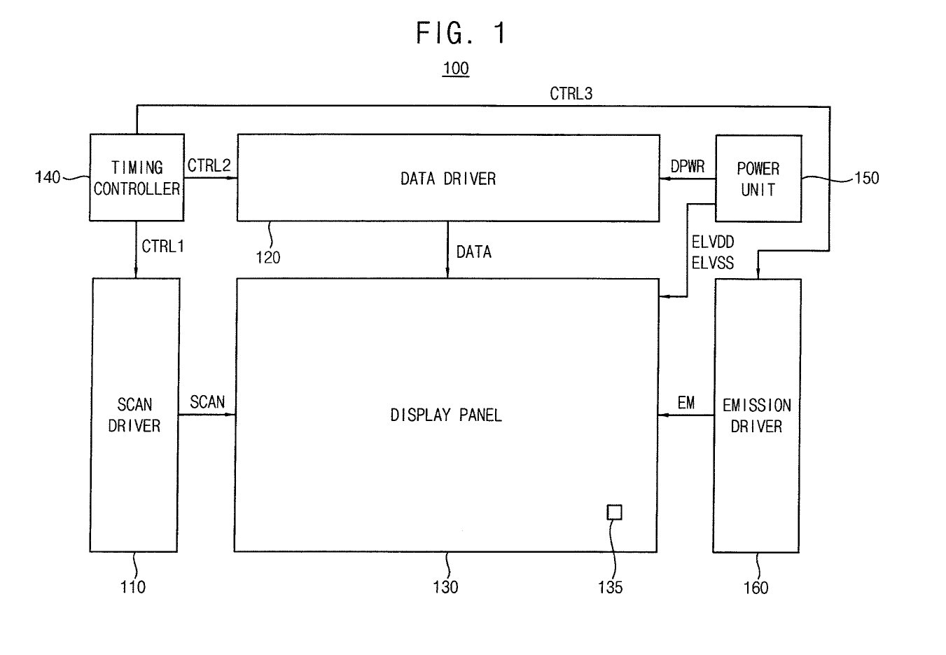

FIG. 1 illustrates an embodiment of a display device 100 which includes a scan driver 110, a data driver 120, a display panel 130, a timing controller 140, and a power unit 150. The display device may also include an emission driver 160 according to one embodiment.

The scan driver 110 generates a scan signal SCAN to be applied to a pixel 135 through a scan line. The pixel 135 receives a data voltage DATA having an intermediate data voltage and a target data voltage during an active period of the scan signal. In one embodiment, the intermediate data voltage may have a voltage level lower than a voltage level of the target data voltage. In another embodiment, the intermediate data voltage may have a voltage level higher than a voltage level of the target data voltage.

The data driver 120 may apply the data voltage DATA to a data line during the active period of the scan signal. The data driver 120 may determine a transmission duration of at least one intermediate data voltage according to a transmission distance from the data driver 120 to the pixel 135, and may sequentially apply the intermediate data voltage and the target data voltage as the data voltage DATA to the data line based on the transmission duration of the intermediate data voltage during the active period.

The display panel 130 includes the pixel 135, which receives the data voltage DATA based on the intermediate data voltage and the target data voltage applied to the data line during the active period. In one embodiment, the data voltage DATA may correspond to a node voltage of a portion of the data line adjacent to the pixel which reaches the target data voltage at an end point of the active period of the scan signal. The portion may be a node of the data line DL connected to the pixel 135 receiving an activated scan signal. The pixel 135 may emit light based on the data voltage DATA (especially, the target data voltage).

The timing controller 140 calculates a transmission distance from the data driver 120 to the pixel 135, and controls the scan driver 110 and the data driver 120. In one embodiment, the timing controller 140 may control the emission driver 160. The timing controller 140 may control the scan driver 110 based on a first control signal CTRL1, control the data driver 120 based on a second control signal CTRL2, and control the emission driver 160 based on a third control signal CTRL3.

The power unit 150 applies a data power voltage DPWR to the data driver 120, and applies pixel power voltages ELVDD and ELVSS to the display panel 130. The data driver 120 generates data voltages DATA based on the data power voltage DPWR. The pixel 135 in the display panel 130 emits light based on the data voltage (e.g, the target data voltage of the data voltage) and the pixel power voltages ELVDD and ELVSS.

The emission driver 160 applies an emission signal EM to the display panel 130. The pixel 135 emits light based on the data voltage (e.g., the target data voltage of the data voltage) during an emission signal active period.

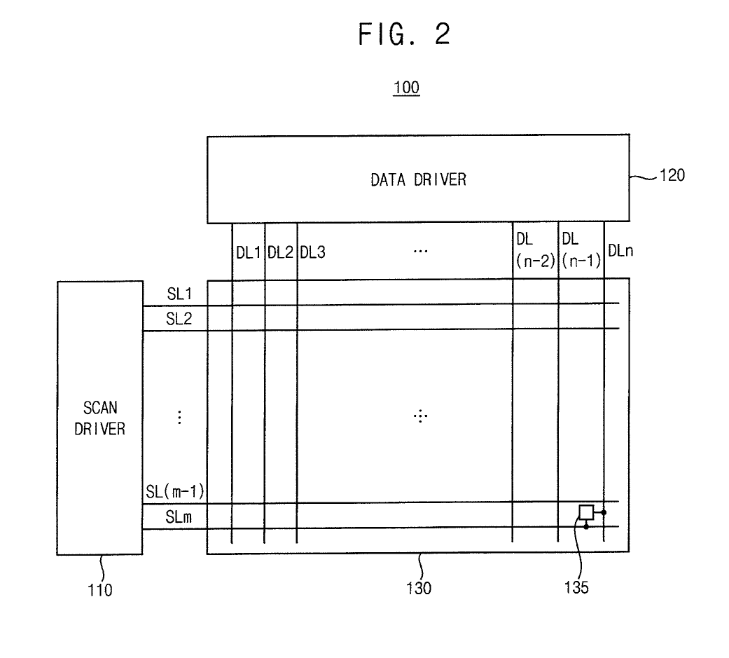

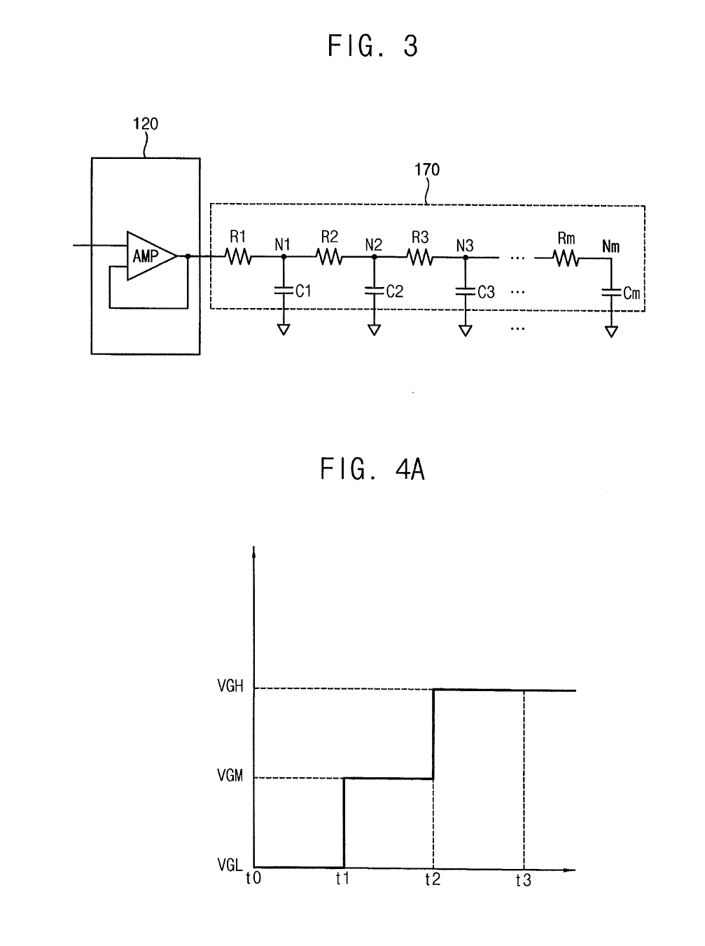

FIG. 2 illustrates an example of a data line connected between a data driver and a pixel, and a scan line connected between a scan driver and the pixel of the display device of FIG. 1. FIG. 3 illustrates an example of an equivalent circuit of a data line connected to the data driver of FIG. 1.

Referring to FIGS. 2 and 3, one of the scan lines SL1, SL2, . . . , SL(m-1), SLm (m is an integer greater than 1) is connected between the scan driver 110 and the pixel 135. One of the data lines DL1, DL2, . . . , DL(n-1), DLn (n is an integer greater than 1) is connected between the data driver 120 and the pixel 135.

The data driver 120 may include an amplifier AMP which operates as a voltage follower. An nth data line DLn and 170 may include first to (m)th resistors R1, R2, R3, . . . , Rm and first to (m)th capacitors C1, C2, C3, . . . , Cm.

The scan driver 110 generates a scan signal and applies the scan signal to the pixel 135 through the scan line SLm.

The data driver 120 determines a transmission duration of at least one intermediate data voltage according to a transmission distance from the data driver 120 to the pixel 135, and sequentially applies the intermediate data voltage and a target data voltage to first to (n)th data lines DL1, DL2, . . . , DL(n-1), DLn during the active period of the scan signal.

The (n)th data line DLn and 170 include a first node N1 connected to a pixel in a first row, a second node N2 connected to a pixel in a second row, a third node N3 connected to a pixel in a third row, and an (m)th node Nm connected to a pixel in a (m)th row. In one embodiment, the first to (m)th rows correspond to the first to (m)th scan lines SL1, SL2, . . . , SL(m-1), SLm, respectively. A transmission distance from the data driver 120 to the first node N1 is the shortest, and a transmission distance from the data driver 120 to the (m)th node Nm is the longest.

In one embodiment, as the transmission distance increases, the transmission duration of the intermediate data voltage may decrease, and a transmission duration of the target data voltage may increase. For example, the transmission duration of the intermediate data voltage according to a first distance from the data driver 120 to a first pixel may be longer than the transmission duration of the intermediate data voltage according to a second distance from the data driver 120 to a second pixel, when the second distance is longer than the first distance.

For example, the data voltage may include a high-level data voltage corresponding to a target data voltage and a low-level data voltage lower than the high-level data voltage. The data voltage may further include an intermediate data voltage between the high-level data voltage and the low-level data voltage.

The target data voltage and the intermediate data voltage may be sequentially applied to the data line 170 according to voltage level. In one embodiment, the data driver 120 applies the intermediate data voltage to the pixel 135 during a first portion of the active period corresponding to the determined transmission duration (e.g., the transmission duration of the intermediate data voltage), and applies the target data voltage to the pixel during a second portion of the active period following the first portion of the active period.

For example, the intermediate data voltage may be applied to the second data line DL2 (during the first portion of the active period) after the low-level data voltage is applied to the second data line DL2. The high-level data voltage (e.g., the target data voltage) may be applied to the second data line DL2 (during the second portion of the active period) after the intermediate data voltage is applied to the second data line DL2. In contrast, the intermediate data voltage may be applied to the third data line DL3 after the high-level data voltage (e.g., the target data voltage) is applied to the third data line DL3. The low-level data voltage may be applied to the third data line DL3 after the intermediate data voltage is applied to the third data line DL3.

The data driver 120 applies a first voltage as the intermediate data voltage to the first pixel located at the first distance from the data driver 120, and applies a second voltage as the intermediate data voltage to the second pixel located at the second distance from the data driver 120. In one embodiment, when the second distance is greater than the first distance, the first voltage may have a voltage level lower than that of the target data voltage, and the second voltage may have a voltage level higher than that of the target data voltage.

In one embodiment, the intermediate data voltage may be generated by a voltage divider which divides the target data voltage. In other words, the intermediate data voltage may be generated by the voltage divider connected to the high-level data voltage and the low-level data voltage. In one embodiment, the voltage divider may be in the data driver 120. In this case, the data driver 120 may generate a voltage level different from a voltage applied from the power unit 150 of FIG. 1.

In one embodiment, the at least one intermediate data voltage may include a plurality of intermediate data voltages having different voltage levels. The data driver 120 sequentially applies the intermediate data voltages and the target data voltage to the data line 170.

In one embodiment, the voltage levels of the intermediate data voltages may be lower than the voltage level of the target data voltage. For example, the data voltage may include the high-level data voltage corresponding to the target data voltage and the low-level data voltage lower than the high-level data voltage. The data voltage may further include a plurality of intermediate data voltages between the high-level data voltage and the low-level data voltage.

The target data voltage and the intermediate data voltages may be sequentially applied to the data line 170 according to voltage level. For example, a first intermediate data voltage may be applied to the second data line DL2 after the low-level data voltage is applied to the second data line DL2. A second intermediate data voltage having a voltage level higher than a voltage level of the first intermediate data voltage may be applied to the second data line DL2 after the first intermediate data voltage is applied to the second data line DL2. The high-level data voltage (e.g., the target data voltage), having a voltage level higher than a voltage level of the second intermediate data voltage, may be applied to the second data line DL2 after the second intermediate data voltage is applied to the second data line DL2.

In contrast, the second intermediate data voltage may be applied to the third data line DL3 after the high-level data voltage (e.g., the target data voltage) is applied to the third data line DL3. The first intermediate data voltage having a voltage level lower than a voltage level of the second intermediate data voltage may be applied to the third data line DL3 after the second intermediate data voltage is applied to the third data line DL3. The low-level data voltage may be applied to the third data line DL3 after the first intermediate data voltage is applied to the third data line DL3.

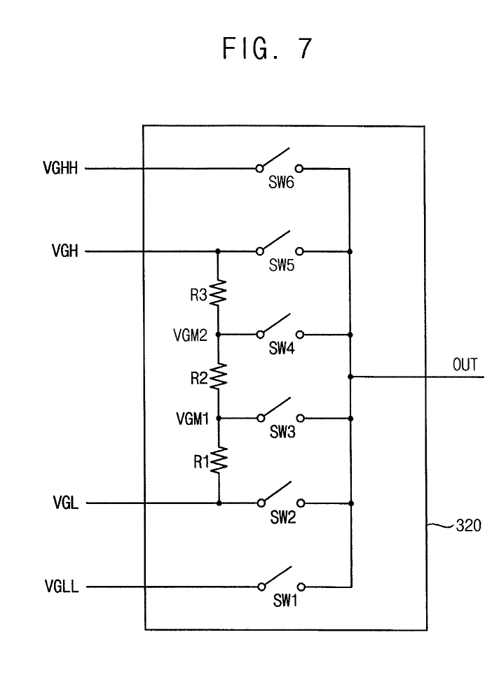

In one embodiment, the first and second intermediate data voltage may be generated by the voltage divider which divides the target data voltage. In other words, the intermediate data voltages may be generated by the voltage divider connected to the high-level data voltage and the low-level data voltage. An embodiment of the voltage divider is described with reference to FIG. 7. In one embodiment, the voltage divider may be in the data driver 120. In this case, the data driver 120 may generate a voltage having a voltage level different from a voltage level applied from the power unit 150 of FIG. 1.

The data driver 120 determines a transmission duration of the intermediate data voltage according to a transmission distance from the data driver 120 to the pixel 135. In this case, the pixel 135 is a target pixel. In one embodiment, the transmission duration of the intermediate data voltage may be determined to decrease a transmission duration of the target data voltage when the node voltage has a voltage level of the target data voltage. In one embodiment, as the transmission distance increases, the transmission duration of the intermediate data voltage decreases, and a transmission duration of the target data voltage may increase. A voltage charging time for a voltage level of the first to (n)th data lines DL1, DL2, DL3, . . . , DL(n-2), DL(n-1), DLn reaching the target data voltage (or the high-level data voltage) may be proportional to the transmission distance.

Thus, when the high-level data voltage is applied to the data line 170 after the low-level data voltage applied, a first transition duration for a node voltage of a first portion (e.g., the first node Ni) of the data line 170 being changed to the high-level data voltage may be shorter than a second transition time for a node voltage of a second portion (e.g., the (m)th node Nm) of the data line being changed to the high-level data voltage.

A transmission distance from the data driver 120 to the first portion of the data line may be shorter than a transmission distance from the data driver 120 to a center portion of the data line 170. A transmission distance from the data driver 120 to the second portion of the data line may be longer than the transmission distance from the data driver 120 to a center portion of the data line 170.

When a target pixel which receives an activated scan signal is coupled to the first node N1, the data driver 120 may apply the target data voltage to the (n)th data line DLn and 170 so that a voltage of the first node N1 may reach the target data voltage prior to a voltage of the (m)th node Nm. In other words, the transmission duration of the target data voltage of the first node N1 may be longer than the transmission duration of the target data voltage of the (m)th node Nm. As a result, the target pixel may receive the node voltage of the first node Ni corresponding to the target data voltage at an end point of the scan signal active period.

Respective voltages of the other nodes N2, N3, . . . , Nm of the (n)th data line DLn and 170 may be unintentionally changed to the target data voltage. Thus, the display device 100 may unnecessarily consume power (or energy) for changing the voltages of the second to (m)th nodes N2, N3, . . . , Nm. However, it is not necessary that the voltages of the second to (m)th nodes N2, N3, . . . , Nm reach the target data voltage.

Thus, if the voltage changes of the second to (m)th nodes N2, N3, . . . , Nm decreases, power consumption of the display device 100 may decrease. The transmission duration of the target data voltage of the first node N1 decreases so that the voltage changes of the second to (m)th nodes N2, N3, . . . , Nm may decrease. Therefore, the transmission duration of the target data voltage of the first node N1 decreases so that power consumption of the display device 100 may decrease.

The target pixel may receive the node voltage of the first node N1 as the data voltage at the end point of the active period of the scan signal. Thus, when the node voltage of the first node N1 corresponds to the target data voltage at the end point of the active period, then the target pixel may receive the target data voltage.

Thus, the data driver 120 may determine the transmission duration of the intermediate data voltage according to a transmission distance from the data driver 120 to the target pixel. For example, the transmission distance from the data driver 120 to the first node N1 is relatively shorter than the transmission distance from the data driver 120 to a center portion of the data line 170. The transmission duration of the intermediate data voltage of the first node Ni may therefore be relatively longer than transmission durations of the intermediate data voltages of the center portion.

In contrast, the transmission distance from the data driver 120 to the (m)th node Nm is longer than the transmission distance from the data driver 120 to a center portion of the data line 170. The transmission duration of the intermediate data voltage of the (m)th node Nm may therefore be relatively shorter than the transmission durations of the intermediate data voltages of the center portion. As the transmission duration of the intermediate data voltage is determined according to the transmission distance to the target pixel, the transmission duration of the target data voltage may decrease. As a result, voltage level changes of the nodes that are farther than the target pixel (e.g., a node adjacent to the target pixel) from the data driver 120 may decrease. Thus, power consumption of the display device 100 may decrease.

In one embodiment, the data driver 120 may apply an emphasis voltage as the intermediate data voltage to the pixel (e.g., the target pixel). A voltage level of the emphasis voltage may be higher than a voltage level of the target data voltage. For example, the data driver 120 may apply the emphasis voltage (e.g., an emphasis voltage of the high-level data voltage) having the voltage level higher than the voltage level of the target data voltage to the data line 170.

In another embodiment, the data driver 120 may further apply an emphasis voltage (e.g., an emphasis voltage of the low-level data voltage) having a voltage level lower than the voltage level of the target data voltage to the data line 170. A charging time, for the voltage level of the node voltage of the (m)th node Nm being changed to the voltage level of the target data voltage, may be decreased by applying the emphasis voltage to the data line 170.

The voltage of the (m)th node Nm may not reach the target data voltage level when the transmission distance is sufficiently long. Thus, the transmission duration of the intermediate data voltage may be adjusted to a predetermined value, e.g., 0. In other words, the transmission duration of the intermediate data voltage may not exist. In addition, the emphasis voltage of the high-level data voltage may be applied in a certain duration prior to applying the high-level data voltage, or the emphasis voltage of the low-level data voltage may be applied in a certain period prior to applying the low-level data voltage.

When the emphasis voltage of the high-level data voltage is applied to the data line 170 prior to the high-level data voltage, the voltage level of the (m)th node Nm may be more quickly changed than when the emphasis voltage of the high-level data voltage is not applied to the data line 170. On the other hand, when the emphasis voltage of the low-level data voltage is applied to the data line 170 prior to the low-level data voltage, the voltage level of the (m)th node Nm may be more quickly changed than when the emphasis voltage of the low-level data voltage is not applied to the data line 170. As a result, the voltage level of the (m)th node Nm may reach the target data voltage before the end point of the active period of the scan signal.

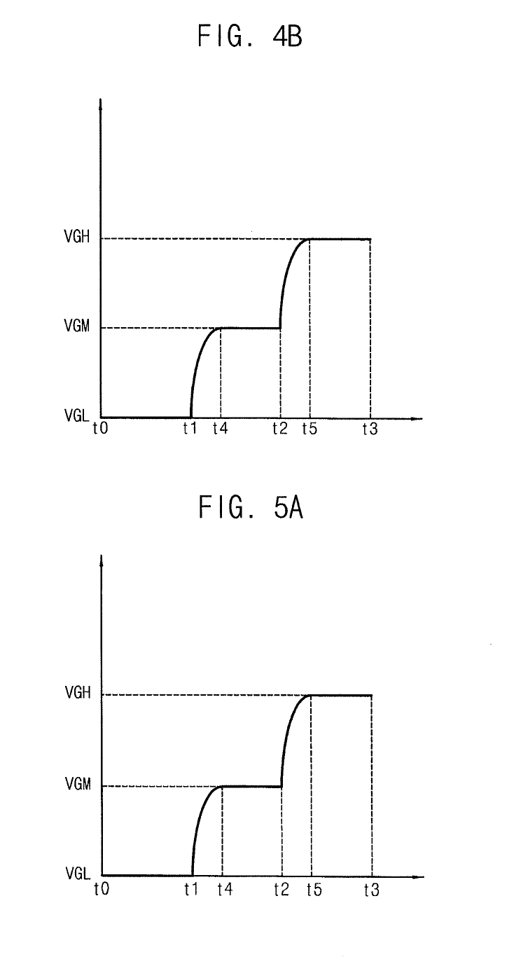

FIG. 4A illustrates an example of a data voltage applied from a data driver, and FIG. 4B illustrates an example of a voltage of a portion of a data line changed by the data voltage of FIG. 4A.

Referring to FIGS. 1, 4A and 4B, in an active period of a scan signal (between times t0 and t3 of FIGS. 4A and 4B), the data driver 120 applies a low-level data voltage VGL to the data line DL between t0 and t1, applies an intermediate data voltage VGM to the data line DL between t1 and t2, and applies a high-level data voltage (e.g., a target data voltage) VGH to the data line DL between t2 and t3. As a result, the node voltage of a portion of the data line DL may change from the low-level data voltage VGL to the intermediate data voltage VGM, and may have a first transient state between t1 and t4 when the node voltage changes from the low-level data voltage VGL to the intermediate data voltage VGM.

The node voltage may change from the intermediate data voltage VGM to the high-level data voltage VGH, and may have a second transient state between t2 and t5 when the node voltage changes from the intermediate data voltage VGM to the high-level data voltage VGH. The portion of the data line DL may be adjacent to the pixel (eg., a target pixel). In other words, the portion of the data line DL may be a node connected to a target pixel. The node voltage may correspond to the data voltage applied to the target pixel.

The data driver 120 may determine a transmission duration of the intermediate data voltage VGM (e.g., determine a length between t1 and t2) so that a transmission duration of the target data voltage (e.g., a duration between t5 and t3) when the node voltage corresponds to the target data voltage (e.g., the high-level data voltage) may be adjusted. For example, the transmission duration of the intermediate data voltage VGM (e.g., the time between t1 and t2) may be increased to decrease the transmission duration of the target data voltage (e.g., the time between t5 and t3). The transmission duration of the target data voltage (e.g., the time between t5 and t3) decreases so that power consumption of the display device 100 may decrease.

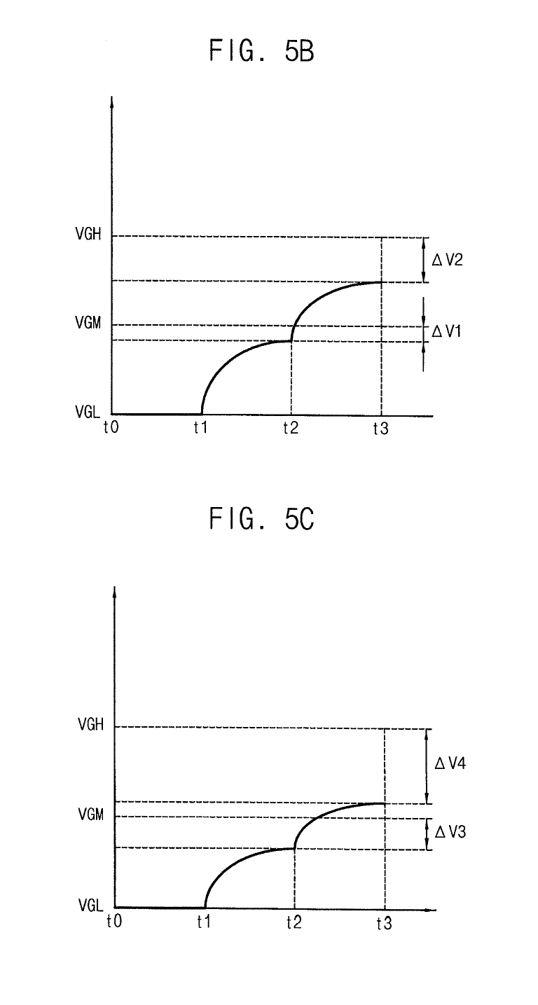

FIG. 5A illustrates an example of a node voltage of a portion of a data line changed by the data voltage of FIG. 4A. FIG. 5B illustrates an example of a node voltage of another portion of a data line changed by the data voltage of FIG. 4A. FIG. 5C illustrates an example of a node voltage of another portion of a data line changed by the data voltages of FIG. 4A.

Referring to FIGS. 5A to 5C, voltages (or node voltages) of each portion of the data line may change when the data voltage having a intermediate data voltage and a target data voltage from the data driver 120 is applied to a pixel (a target pixel) adjacent to a first portion of the data line, during an active period of a scan signal (between times t0 and t3 of FIGS. 5A to 5C). In this case, the first portion of the data line is closer to the data driver 120 than a center portion of the data line.

FIG. 5A shows a node voltage change at the first portion, and/or at a portion closer to the data driver 120 than the first portion, when the data voltage is applied to the pixel adjacent to the first portion of the data line. As illustrated in FIG. 5A, the node voltage of the first portion may change from the low-level data voltage VGL to the intermediate data voltage VGM, and may have a first transient state between t1 and t4 when the node voltage changes from the low-level data voltage VGL to the intermediate data voltage VGM. The node voltage may change from the intermediate data voltage VGM to the high-level data voltage VGH (e.g., a target data voltage), and may have a second transient state between t2 and t5 when the node voltage changes from the intermediate data voltage VGM to the high-level data voltage VGH.

FIG. 5B shows a node voltage change at a second portion of the data line when the data voltage is applied to the pixel adjacent to the first portion of the data line. A transmission distance between the data driver 120 and the second portion may be substantially the same as a transmission distance between the data driver and the center portion of the data line.

As illustrated in FIG. 5B, the node voltage of the second portion may change from the low-level data voltage VGL to a first voltage VGM−ΔV1, which corresponds to the intermediate data voltage VGM minus a first difference value ΔV1, during a period between t1 and t2. The node voltage of the second portion may change from the first voltage VGH−ΔV2 to a second voltage, which corresponds to the high-level data voltage VGH minus a second difference value ΔV2, during a period between t2 and t3.

FIG. 5C shows a node voltage change at a third portion of the data line when the data voltage is applied to the pixel adjacent to the first portion of the data line. A transmission distance between the data driver and the third portion of the data line may be longer than the transmission distance between the data driver and the center portion of the data line.

As illustrated in FIG. 5C, the node voltage of the third portion may change from the low-level data voltage VGL to a third voltage VGM−ΔV3, which corresponds to the intermediate data voltage VGM minus a third difference value ΔV3, during the period between t1 and t2. The node voltage of the third portion may change from the first voltage VGH−ΔV4 to a fourth voltage, which corresponds to the high-level data voltage VGH minus a fourth difference value ΔV4, during the period between t2 and t3.

The node voltage of the first portion may correspond to the intermediate data voltage VGM in an intermediate data voltage period between t4 and t2, and may correspond to the high-level data voltage VGH in a high-level data voltage period between t5 and t3. However, the node voltage of the second portion and the node voltage of the third portion may not have the intermediate data voltage period and the high-level data voltage period.

The node voltage of the second portion may be lower than the high-level about the second difference value ΔV2 at an end point t3 of the active period of the scan signal. Thus, energy consumption (or power consumption) at the second portion may be reduced in accordance with Equation 1.

$${E}_{1} = \frac{1}{2} \times {C}_{DATA 1} \times ( {VGH}^{2} - {( VGH - Δ2 )}^{2} ) \qquad ( 1 )$$

where E1=the energy consumption at the second portion of the data line, C_{DATA1}=a capacitance of the second portion, VGH=a high-level data voltage level, and ΔV2=the second difference value.

Meanwhile, the node voltage of the third portion may be lower than the high-level about the fourth difference value ΔV4 at the end point t3 of the active period of the scan signal. Thus, energy consumption (or power consumption) at the third portion may be reduced in accordance with Equation 2.

$${E}_{2} = \frac{1}{2} \times {C}_{DATA 2} \times ( {VGH}^{2} - {( VGH - Δ4 )}^{2} ) \qquad ( 2 )$$

where: E1=the energy consumption at the third portion of the data line, C_{DATA2}=a capacitance of the third portion, VGH=a high-level data voltage level, and V4=the fourth difference value.

As described above, the energy consumption at portions of data line may be reduced when the data voltage has the intermediate voltage.

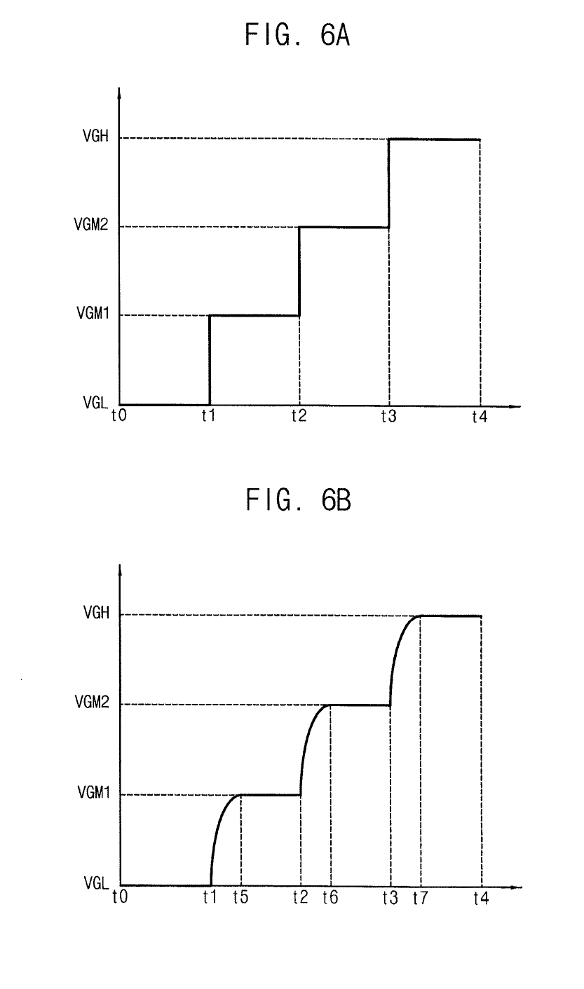

FIG. 6A illustrates another example of a data voltage applied from a data driver, and FIG. 6B illustrating an example of a voltage of a portion of a data line changed by the data voltage of FIG. 6A.

Referring to FIGS. 6A and 6B, in a scan signal active period (between times tO and t4 of FIGS. 6A and 6B), the data driver 120 applies a low-level data voltage VGL to the data line DL between t0 and t1, applies a first intermediate data voltage VGM1 to the data line DL between t1 and t2, applies a second intermediate data voltage VGM2 to the data line DL between t2 and t3, and applies a high-level data voltage (e.g., a target data voltage) VGH to the data line DL between t3 and t4.

As a result, the node voltage of a portion of the data line DL may change from the low-level data voltage VGL to the first intermediate data voltage VGM, and may have a first transient state between t1 and t5 when the node voltage changes from the low-level data voltage VGL to the first intermediate data voltage VGM1. The node voltage may change from the first intermediate data voltage VGM1 to the second intermediate data voltage VGM1, and may have a second transient state between t2 and t6 when the node voltage changes from the first intermediate data voltage VGM1 to the second intermediate data voltage VGM2.

The node voltage may change from the second intermediate data voltage VGM2 to the high-level data voltage VGH, and may have a third transient state between t3 and t7 when the node voltage changes from the second intermediate data voltage VGM2 to the high-level data voltage VGH. The portion of the data line DL may be adjacent to the pixel (e.g., a target pixel). In other words, the portion of the data line DL may be a node connected to a target pixel, and the node voltage may correspond to the data voltage applied to the target pixel.

The data driver 120 determines a transmission duration of the first intermediate data voltage VGM1 (e.g., a time between t1 and t2) and a transmission duration of the second intermediate data voltage VGM2 (e.g., a time between t2 and t3), so that a transmission duration of the target data voltage (e.g., a duration between t7 and t4) when the node voltage corresponds to the target data voltage (e.g., the high-level data voltage) may be adjusted.

For example, the transmission duration of the first intermediate data voltage VGM1 (e.g., the time between t1 and t2) and the transmission duration of the second intermediate data voltage VGM2 (e.g., the time between t2 and t3) may be increased to decrease the transmission duration of the target data voltage (e.g., the time between t7 and t4). The transmission duration of the target data voltage (e.g., the time between t7 and t4) decreases so that power consumption of the display device 100 may decrease.

FIG. 7 illustrates an embodiment of a voltage divider, which, for example, may be included in the display device of FIG. 1. Referring to FIG. 7, the voltage divider 320 may include first to sixth switches SW1, SW2, SW3, SW4, SW5, and SW6 and first to third resistors R1, R2, and R3.

The first switch SW1 may apply an emphasis voltage of a low-level data voltage VGLL to an output terminal OUT. The second switch SW2 may apply a low-level data voltage VGL to the output terminal OUT. The fifth switch SW5 may apply a high-level data voltage VGH to the output terminal OUT. The sixth switch SW6 may apply an emphasis voltage of the high-level data voltage VGHH to the output terminal OUT.

The first to third resistors R1, R2, and R3 may generate a first intermediate data voltage VGM1 and a second intermediate data voltage VGM2 based on the voltage divider rule. The third switch SW3 may apply the first intermediate data voltage to the output terminal OUT. The fourth switch SW4 may apply the second intermediate data voltage to the output terminal OUT. In one embodiment, the voltage divider may be in the data driver 120 of FIG. 1.

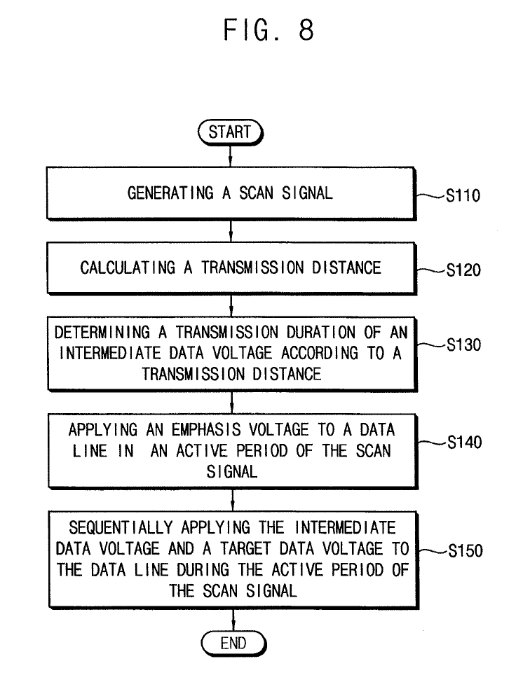

FIG. 8 illustrates an embodiment of a method for driving a display device, which, for example, may be a display device in accordance with one of the aforementioned embodiments.

Referring to FIG. 8, the method includes generating a scan signal S110, and determining a transmission duration of at least one intermediate data voltage according to a transmission distance from a data driver to a pixel S130. The method further includes sequentially applying the intermediate data voltage and a target data voltage to the data line based on the determined transmission duration of the intermediate data voltage during an active period of the scan signal S150.

The method may also include calculating the transmission distance S120. The method may also include applying an emphasis voltage to the pixel. A voltage level of the emphasis voltage may be higher than a voltage level of the target data voltage.

The scan signal may be generated in operation S110. The scan signal may be applied to the pixel through a scan line. The scan signal may be generated by a scan driver, and the scan driver may be controlled by a timing controller.

The transmission distance may be calculated S120. A predetermined transmission distance value corresponding to a certain timing may be stored in the display device. The transmission duration of the intermediate data voltage may be determined in operation S130.

As the transmission distance increases, the transmission duration of the intermediate data voltage may decrease, and a transmission duration of the target data voltage may increase. In other words, the transmission duration of the intermediate data voltage according to a first distance from the data driver to a first pixel may be longer than the transmission duration of the intermediate data voltage according to a second distance from the data driver to a second pixel when the second distance is longer than the first distance. In one embodiment, the transmission duration of the intermediate data voltage may be determined to decrease the transmission duration of the target data voltage. The portion of the data line may be adjacent to the pixel (or a target pixel).

In one embodiment, the transmission duration of the intermediate data voltage may be determined such that the voltage of the portion of the data line adjacent to the pixel reaches the target data voltage at an end point of the active period of the scan signal.

The emphasis voltage may be applied to the data line S140. The emphasis voltage may increase a voltage charging speed of the data line. In one embodiment, the emphasis voltage (e.g., an emphasis voltage of the high-level data voltage) having a voltage level higher than the voltage level of the target data voltage may be applied to the data line. In another embodiment, the emphasis voltage (e.g., an emphasis voltage of the low-level data voltage) having a voltage level lower than the voltage level of the target data voltage may be further applied to the data line. A charging time for the voltage level of the node voltage of the portion being changed to a voltage level of the target data voltage may be reduced by applying the emphasis voltage to the data line 170.

The intermediate data voltage and the target data voltage may be sequentially applied to the data line S150. The intermediate data voltage may be applied to the data line based on the determined transmission duration of the intermediate data voltage. In one embodiment, the intermediate data voltage may have a voltage level lower than a voltage level of the target data voltage. The transmission duration of the intermediate data voltage may be determined such that the voltage of the portion of the data line adjacent to the pixel reaches the target data voltage at an end point of the active period of the scan signal.

In one embodiment, the intermediate data voltage may be generated by a voltage divider which divides the target data voltage. In other words, the intermediate data voltage may be generated by the voltage divider connected to the high-level data voltage and the low-level data voltage. In one embodiment, the voltage divider may be in the data driver. In this case, the data driver may generate a voltage having a voltage level different from a voltage level that is applied from a power unit.

In one embodiment, a first voltage may be applied as the intermediate data voltage to a first pixel located at a first distance from the data driver, and a second voltage may be applied as the intermediate data voltage to a second pixel located at a second distance from the data driver. In this case, when the second distance is greater than the first distance, the first voltage may have a voltage level lower than that of the target data voltage, and the second voltage may have a voltage level higher than that of the target data voltage.

In one embodiment, the at least one intermediate data voltage may include a plurality of intermediate data voltages having different voltage levels. The intermediate data voltages and the target data voltage may be sequentially applied to the data line. The voltage levels of the intermediate data voltages may be lower than the voltage level of the target data voltage. In one embodiment, the transmission duration of the intermediate data voltage may be determined to decrease the transmission duration of the target data voltage. In one embodiment, as the transmission distance increases, the transmission duration of the intermediate data voltage may decrease, and a transmission duration of the target data voltage may increase.

The data voltage may be applied to the pixel (e.g., the target pixel). The data voltage may correspond to the node voltage of the portion being connected to the pixel at the end point of the active period of the scan signal. The pixel may emit light based on the data receiving voltage.

The transmission duration of the intermediate data voltage is controlled according to the transmission distance to the target pixel, so that the transmission duration of the target data voltage may decrease. As a result, the voltage change of the data line decreases so that power consumption (or energy consumption) of the display device may decrease.

Although the example embodiments are described the first and second intermediate data voltages applied to the data line, the number of intermediate data voltages may be different in other embodiments.

The present embodiments may be applied to any display device and any system including the display device. For example, the present embodiments may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A display device, comprising:
a display panel including a pixel;
a scan driver to apply a scan signal to the pixel; and
a data driver to determine a transmission duration of at least one intermediate data voltage based on a transmission distance from the data driver to the pixel, the data driver to sequentially apply the intermediate data voltage and a target data voltage to the pixel based on the transmission duration of the intermediate data voltage during an active period of the scan signal.

2. The device as claimed in claim 1, wherein the data driver is to:
apply the intermediate data voltage to the pixel during a first portion of the active period corresponding to the determined transmission duration, and
apply the target data voltage to the pixel during a second portion of the active period following the first portion of the active period.

3. The device as claimed in claim 1, wherein the intermediate data voltage has a voltage level lower than a voltage level of the target data voltage.

4. The device as claimed in claim 1, wherein, as the transmission distance increases, the transmission duration of the intermediate data voltage decreases, and a transmission duration of the target data voltage increases.

5. The device as claimed in claim 1, wherein the transmission duration of the intermediate data voltage is based on a voltage of a portion of a data line adjacent to the pixel reaching the target data voltage at an end point of the active period of the scan signal.

6. The device as claimed in claim 1, wherein:
the data driver is to apply an emphasis voltage as the intermediate data voltage to the pixel, and
a voltage level of the emphasis voltage is higher than a voltage level of the target data voltage.

7. The device as claimed in claim 1, wherein the data driver is to:
apply a first voltage as the intermediate data voltage to a first pixel located at a first distance from the data driver, and
apply a second voltage as the intermediate data voltage to a second pixel located at a second distance from the data driver, and
wherein the second distance is greater than the first distance, the first voltage has a voltage level lower than that of the target data voltage, and the second voltage has a voltage level higher than that of the target data voltage.

8. The device as claimed in claim 1, wherein the intermediate data voltage is generated by a voltage divider which divides the target data voltage.

9. The device as claimed in claim 8, wherein the voltage divider is in the data driver.

10. The device as claimed in claim 1, wherein:
the at least one intermediate data voltage includes a plurality of intermediate data voltages having different voltage levels, and
the data driver is to sequentially apply the intermediate data voltages and the target data voltage to the pixel.

11. The device as claimed in claim 10, wherein the voltage levels of the intermediate data voltages are lower than a voltage level of the target data voltage.

12. The device as claimed in claim 1, further comprising:
a timing controller to calculate the transmission distance and to control the scan driver and the data driver.

13. A method of driving a display device, comprising:
generating a scan signal;
determining a transmission duration of at least one intermediate data voltage according to a transmission distance from a data driver to a pixel; and
sequentially applying the intermediate data voltage and a target data voltage to the pixel based on the determined transmission duration of the intermediate data voltage during an active period of the scan signal.

14. The method as claimed in claim 13, wherein sequentially applying the intermediate data voltage and the target data voltage to the pixel includes:
applying the intermediate data voltage to the pixel during a first portion of the active period corresponding to the determined transmission duration; and
applying the target data voltage to the pixel during a second portion of the active period following the first portion of the active period.

15. The method as claimed in claim 13, wherein the intermediate data voltage has a voltage level lower than a voltage level of the target data voltage.

16. The method as claimed in claim 13, wherein, as the transmission distance increases, the transmission duration of the intermediate data voltage decreases, and a transmission duration of the target data voltage increases.

17. The method as claimed in claim 13, wherein the transmission duration of the intermediate data voltage is based on a voltage of a portion of a data line adjacent to the pixel reaching the target data voltage at an end point of the active period of the scan signal.

18. The method as claimed in claim 13, wherein:
an emphasis voltage is applied as the intermediate data voltage to the pixel, and
a voltage level of the emphasis voltage is higher than a voltage level of the target data voltage.

19. The method as claimed in claim 13, wherein:
a first voltage is applied as the intermediate data voltage to a first pixel located at a first distance from the data driver, and a second voltage is applied as the intermediate data voltage to a second pixel located at a second distance from the data driver, and
the second distance is greater than the first distance, the first voltage has a voltage level lower than that of the target data voltage, and the second voltage has a voltage level higher than that of the target data voltage.

20. The method as claimed in claim 13, wherein:
the at least one intermediate data voltage includes a plurality of intermediate data voltages having different voltage levels,
the intermediate data voltages and the target data voltage are sequentially applied to the pixel, and
the voltage levels of the intermediate data voltages are lower than a voltage level of the target data voltage.
